(19) United States
(12) Patent Application Publication
(10) Pub. No.: US 2026/0283410 A1
(43) Pub. Date: Sep. 24, 2026

(54) MAGNETIC CUTTING BOARD WITH SUPPORT BLOCKS

(71) Applicants: Jeffrey Russel Dame, North Ogden, UT (US); Holly Lynn Dame, North Ogden, UT (US)

(72) Inventors: Jeffrey Russel Dame, North Ogden, UT (US); Holly Lynn Dame, North Ogden, UT (US)

(21) Appl. No.: 19/086,008

(22) Filed: Mar. 20, 2025

(51) Int. Cl. A47J 47/00

(52) U.S. Cl. CPC A47J 47/005

(57) ABSTRACT

An assembly that includes a cutting board with one or more first magnets embedded below a cutting surface of the cutting board. The assembly may also include a support block comprising a second magnet or ferromagnetic metal embedded within the support block. The second magnet or ferromagnetic metal may be configured to be attracted to any of the one or more first magnets of the cutting board. The support block is also configured to support a food item to be sliced. The cutting board may include a lip that extends along a perimeter of the cutting board and a spout may be defined within the lip. The spout may span from the cutting surface to a top edge of the lip. The lip and the spout may be comprised of a rigid silicone material and the lip may have a height between one to three inches.

### TECHNICAL FIELD

The instant specification generally relates to cutting board systems and assemblies. More specifically, the instant specification relates to a cutting board system with a magnetic cutting board with support blocks.

### BACKGROUND

Certain existing cutting boards are designed to protect countertops or other surfaces that can be damaged easily while cutting or chopping different food items with a knife or other cutting instrument. Such cutting boards are substantially horizontal and are dimensioned to easily fit in a kitchen drawer or cupboard. While the flat or horizontal design used in existing cutting boards makes the cutting boards easy to store, the flat design also makes these cutting boards prone to allow juices or food fragments to spill over the edge of the cutting board and onto a counter on which the cutting board rests. The resulting mess worsens user experience by causing the user to spend extra time cleaning, not only the cutting board but also the areas on the counter affected by spillover. Such a cutting board design is also not conducive to cutting objects that can slide or roll around on the cutting board surface while being cut, such as melons, onions, and other round produce or foods. Users are often required to stabilize these types of food (e.g. large, round, or slippery) with one hand while manipulating a knife or other cutting instrument in the other, which may not be an option for all users, such as users who may only have one useable hand or only one hand.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is an exploded view of an example embodiment of a cutting board and support block assembly by which selected aspects of the present disclosure may be implemented, in accordance with various embodiments.

FIG. 2 is a perspective view of an example embodiment of a cutting board, in accordance with various embodiments.

FIG. 3 is a perspective view of another example embodiment of a cutting board, in accordance with various embodiments.

FIG. 4A is a perspective view of an example embodiment of a support block, in accordance with various embodiments.

FIG. 4B is a perspective top view of another example embodiment of a support block, in accordance with various embodiments.

FIG. 5 is a perspective view of an assembled cutting board and support block assembly, in accordance with various embodiments.

### DETAILED DESCRIPTION

The above-mentioned deficiencies of certain existing cutting boards, e.g. being unable to contain large amounts of fluids and to provide support for the object being cut, are readily apparent in trying to cut a watermelon on these cutting boards. Watermelons are large, round, and often contain more juice than can rest or be contained on the surface of such existing cutting boards. As users cut a watermelon on these cutting boards, the juices from the melon can spill directly off of the cutting board onto the counter or can be pushed onto the counter (along with seeds or other previously cut watermelon piece) by uncut portions of the watermelon as the user maneuvers the uncut portions for the next cut. While the mess is especially prominent in the case of a watermelon, one of ordinary skill in the art will recognize that other produce or food (e.g., melons, apples, onions, etc.) will also result in messes that are not easily contained by certain existing cutting boards. Even where some existing cutting boards have implemented indentations or moats in the cutting surface of the cutting board that are meant to capture liquids while food is being cut, the flat design of these cutting boards often prevents the moats from being sufficiently deep to contain all the liquids produced by a watermelon. The shallow depth of these moats is also often insufficient to prevent previously cut pieces of food from being pushed over an edge of the cutting board.

In addition to inadequately containing liquids or food chunks, existing cutting boards provide little to no support for the object being cut. Turning again to the example of the watermelon, many of the cuts needed to reduce the watermelon to servable portions (e.g. halving, quartering, etc.) requires the user to use both hands to execute. For example, to cut a watermelon in half the user must stabilize the watermelon with one hand and manipulate a knife or cutting utensil with the other. And, even when the halving cut is made, the half of the watermelon that is not being stabilized by the user's non-cutting hand is prone to roll or shift once cut. The moving half can leak or push juices over the edge of the cutting board onto the counter. To prevent the moving half from causing a mess or falling off the counter, the user can be forced to use both hands to stabilize the halves of the watermelon. The process of adjusting and stabilizing the different portions of the watermelon being cut can be a tedious and messy process. This is especially true in the case that a user only has one useable hand or only one hand. Having only one useable hand can make using certain existing cutting boards to cut an object like a watermelon prohibitive due to the lack of support provided by a flat cutting board to the object being cut. Again, while referring to the example of a watermelon being cut, one of ordinary skill in the art will recognize that other foods will result in the same or similar issues of being difficult to cut with one hand (e.g. foods that are large, round, or slippery).

Additionally, others have tried creating solutions to make it easier for one-handed users to cut objects that are difficult to cut on certain existing cutting boards (e.g. large, round, or slippery food or produce), but these solutions typically involve bulky contraptions or extra components that can get in the way of a user's knife and are difficult or tedious to clean.

Aspects and implementations of the present disclosure address the above and other deficiencies by providing assemblies, systems, and apparatuses that can include a cutting board and support blocks. The cutting board may include a raised lip that extends along the perimeter of the cutting board that can contain liquids released from food that has been cut. The raised lip may also act as a barrier to prevent food or liquid from being pushed off the cutting board while a user maneuvers objects on the surface of the cutting board. The cutting board may also include embedded magnets or ferromagnetic metal. The support blocks may also include embedded magnets or ferromagnetic metal that is attracted to the embedded magnets or ferromagnetic metal embedded in the cutting board. One or more support blocks may be placed on the cutting board surface and held in place by an attractive magnetic force created between the embedded material in the one or more support blocks and the embedded material in the cutting board. The one or more support blocks may be used to support food items that are to be cut to prevent the food item, or portions of the food item, from shifting or rolling around while being cut. The attractive force holding one or more support blocks to the cutting board surface may operate to stabilize an object to be cut and assist a user in cutting the object by providing resistance to lateral forces created by a user cutting through the object.

These improvements provide advantages over prior attempts at solutions by increasing user safety in stabilizing objects to be cut, making the cutting process easier by stabilizing the object being cut from movement and requiring a user to use less force to cut an object than if the object was not supported, improving user experience by preventing users from spending extra time and effort cleaning up messes that are not contained by the cutting board, and more. To provide additional ease in cleaning, the cutting board and the support blocks may be made of a dishwasher safe material to allow users to clean the components in a dishwasher. The qualities of a dishwasher safe material will be described in more detail below. Additional advantages will be apparent to those of skill in the art of cutting board assemblies, systems, and apparatuses in the below description.

In some embodiments, an assembly may include a cutting board and a support block. The cutting board may include one or more first magnets embedded below a cutting surface of the cutting board. In some embodiments, the one or more first magnets embedded below the cutting surface of the cutting board are embedded within a rigid silicone material. The support block may include a second magnet or ferromagnetic metal embedded within the support block. In some embodiments, the support block includes more than one second magnet or ferromagnetic metal embedded within the support block. The second magnet or ferromagnetic metal embedded within the support block may be embedded within the support block in a location and an orientation such that the second magnet or ferromagnetic metal may be attracted to any of the one or more first magnets embedded below the cutting surface of the cutting board. The support block may be designed to support a food item that is to be sliced on the cutting surface of the cutting board. The support block may be held flush with the cutting surface of the cutting board by an attractive force produced between a first magnet and a second magnet. The attractive force may prevent the support block from slipping when a lateral force is exerted on the block by the object being cut. In some embodiments, the support block may include one side that is curved to mate against a rounded surface of a food item.

In some embodiments, the cutting board includes a raised lip that extends along a perimeter of the cutting board. In other embodiments, the cutting board includes a spout defined within the lip where the spout spans from the cutting surface of the cutting board to a top edge of the lip. The spout may be defined in a corner formed by the lip and the cutting board. In some embodiments, the spout is defined within the lip at any point along a perimeter of the lip. In some embodiments, the cutting board includes more than one spout defined within the lip.

In some embodiments, the lip and the spout are composed of a rigid silicone material. In another embodiment, the lip is of a height of between one to three inches. In some embodiments, the one or more first magnets embedded below the cutting surface of the cutting board are permanent magnets and the support block includes ferromagnetic metal embedded within the support block. In another embodiment, the one or more first magnets embedded below the cutting surface of the cutting board are permanent magnets and the support block includes a permanent magnet embedded within the support block. In some embodiments, the one or more first magnets are organized into a grid that is sized to encompass a melon of varying sizes. Part of the grid may be sized to fit a specific melon or type of fruit (e.g. a watermelon, a cantaloupe, etc.) or may be sized to fit most melons or fruits, which can vary in size. The second magnet or ferromagnetic metal embedded within the support block may also be embedded within a rigid silicone material. In some embodiments, the assembly includes a plurality of support blocks, where each support block of the plurality of support blocks includes the second magnet or ferromagnetic metal to be attracted to any of the one or more first magnets.

In some embodiments, a system includes a cutting board and a support block. The cutting board may include a ferromagnetic core or plate embedded below a cutting surface of the cutting board. The support block may include a magnet embedded within the support block. In some embodiments, the support block includes more than one magnet embedded within the support block. The magnet embedded in the support block may be attracted to the ferromagnetic core of the cutting board. The support block may also be configured to support a food item to be sliced.

In some embodiments, the cutting board includes a raised lip that extends along a perimeter of the cutting board. The cutting board may also include a spout defined within the lip, wherein the spout spans from the cutting surface to a top edge of the lip. In some embodiments, a length and a width of the ferromagnetic core embedded below the cutting surface of the cutting board are substantially equal to a length and a width of the cutting surface. The length of the cutting surface may be between 15 and 25 inches and the width of the cutting surface may be between 12 and 18 inches. In some embodiments, the support block includes at least one side that is curved to mate against a rounded surface of the food item. The system may include a plurality of support blocks, which include the support block, where each support block of the plurality of support blocks includes the magnet that is attracted to the ferromagnetic core.

A support block is also disclosed according to some embodiments. The support block may include a solid body. The support block may include a first magnet embedded within the solid body. The first magnet may be embedded within a rigid silicone material inside of the solid body. The first magnet may be configured to be attracted to a second magnet or a ferromagnetic metal embedded below a cutting surface. Ferromagnetic metals will be described more particularly below. The support block may be configured to support a food item that is sliced. In some embodiments, at least one side of the support block is curved to mate against a rounded surface of the food item. In other embodiments, a height of the support bock is between one and four inches, a length of the support block is between two and five inches, and a width of the support block is between one and three inches.

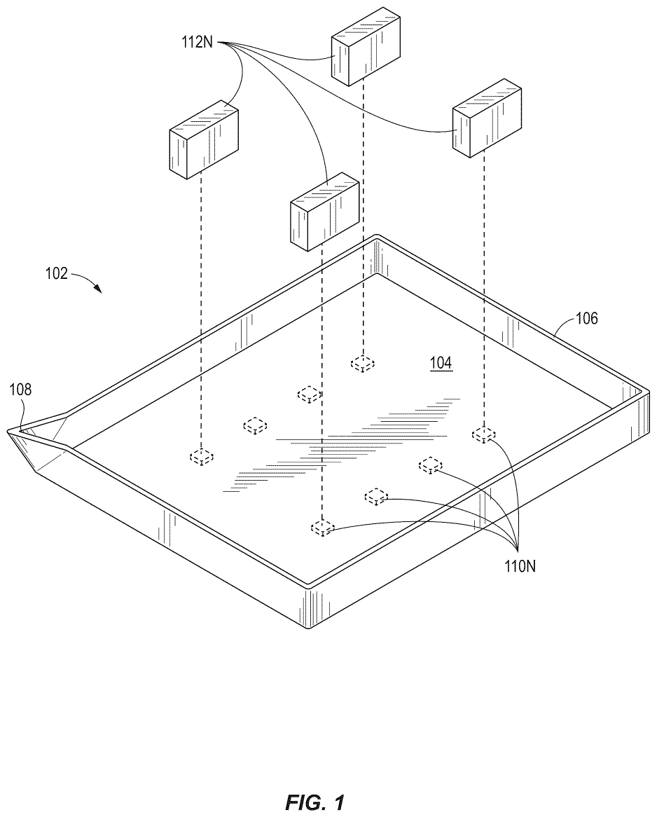

FIG. 1 depicts an exploded, perspective view of an example embodiment of a cutting board and support block assembly 100. The assembly 100 may include a cutting board 102 with a cutting surface 104. The cutting board 102 may be composed of a dishwasher safe material to allow a user to clean the cutting board 102 in a dishwasher. A dishwasher safe material, as described herein, is a material that possesses qualities that allow the material to withstand the conditions that are present inside an operating dishwasher without being damaged or degraded. These conditions can include high temperatures (i.e. temperatures about 130-140° F.), high water pressures (i.e. water pressures about 20 -120 PSI), and abrasion from detergents. Examples of dishwasher safe materials can include stainless steels, ceramics, glass, heat-resistant plastics, and silicone.

In some embodiments, the cutting board 102 is made from an eco-friendly material. An eco-friendly material, as used herein, is a material that has a reduced impact on the environment in terms of sourcing, production, use, and disposal when compared with other materials. Eco-friendly materials with a reduced impact on the environment in terms of sourcing can include materials that are sourced from a renewable source that can naturally replenish over time (e.g. fast-growing plants like bamboo or cork). Eco-friendly materials with a reduced impact on the environment in terms of production can include materials that require minimal water usage during cultivation or extraction (e.g., a crop that thrives in water-scare environments) or materials that are produced through recycling (e.g., recycled paper). Eco-friendly materials with a reduced impact on the environment in terms of use can include materials that do not release harmful chemicals or pollutants during its use (e.g., materials with natural fibers) and materials that are durable and resist wear and tear, reducing the need for replacements. The cutting board 102 may be made from a material that is both eco-friendly and dishwasher safe, i.e. a rigid silicone.

The cutting board 102 may include a raised lip 106. The raised lip 106 may extend along a perimeter of the cutting board. The raised lip 106 may have a height that is between one and three inches. The raised lip 106 may have a height that is between one and three inches to prevent juices or food fragments from being pushed off the cutting surface 104 and still allow the cutting board 102 to be stored in a kitchen drawer or cabinet. The raised lip 106 may also have a width that is between a quarter of an inch and one inch. The width of the raised lip 106 may be between a quarter of an inch and an inch to allow a user to easily maneuver a knife and cut food items on the cutting surface 104 without the raised lip 106 getting in the way of the knife or preventing the knife from cutting all the way to the cutting surface 104. The raised lip 106 may be composed of the same material as the cutting board 102. The raised lip 106 may be composed of a different material than the cutting board 102. The raised lip 106 may be composed of a rigid silicone material.

In some embodiments, the raised lip 106 includes a spout 108. The spout 108 may be defined within the raised lip 106. The spout 108 may span from the cutting surface 104 to a top edge of the raised lip 106. In some embodiments, the spout 108 is angled up to the top of the raised lip 106. In other embodiments, the spout 108 is made to slope up to the top of the raised lip 106. The spout 108 may also include side elements placed from wide to narrow to form a pour area to guide liquids or food particles over the top edge of the raised lip 106 when the cutting board 102 is tilted towards the spout 108. The spout 108 may be composed of the same material as the cutting board 102 and the raised lip 106. The spout 108 may be composed of a different material than the cutting board 102, the raised lip 106, or both. The spout 108 may be defined within a corner of the raised lip 106 and the cutting board 102. The spout 108 may be defined within the raised lip 106 anywhere along the perimeter of the raised lip 106 and the cutting board 102. While one spout 108 is depicted in FIG. 1, one of ordinary skill in the art will recognize that more than one spout may be defined within the raised lip 106 without departing from the scope of the present disclosure.

The cutting surface 104 may be composed of the same material as the cutting board 102. In other embodiments, the cutting surface 104 is composed of a different material than the cutting board 102. In other embodiments, the cutting surface 104 is composed of a material that is dishwasher safe, eco-friendly, or both. The cutting surface 104 may be comprised of a durable material that is resistant to damage from knives, e.g. a rigid silicone, glass, stainless steel, or the like. In some embodiments, the cutting surface 104 is dimensioned so as to fit in a standard kitchen drawer or cabinet while still being large enough to provide a cutting surface for large and/or round food items, e.g., having a length of between 15-25 inches and a width of between 12-18 inches.

In some embodiments, the cutting board 102 includes one or more first magnets 110N embedded below the cutting surface 104. The one or more first magnets 110N may be permanent magnets. Permanent magnets, as used herein, may include rare-earth magnets, such as neodymium (Nd), samarium (Sm), or dysprosium (Dy). Permanent magnets may also include neodymium (NdFeB) or samarium-cobalt (SmCo) magnets or magnets made from an alloy of aluminum (Al), nickel (Ni), and cobalt (Co), along with other elements like copper and iron. Permanent magnets may also include ceramic or ferrite magnets made from iron oxide (Fe2O3) and strontium or barium carbonate or flexible magnets made from a blend of ferrite and rubber or plastic. The type of permanent magnetic used for the one or more first magnets 110N may be selected based on the strength of the magnetic field produced by the specific type of permanent magnetic, the cost of the types of permanent magnets, the food items expected to be cut on the cutting board 102, and more. The one or more first magnets 110N may all be the same kind of permanent magnet. In other embodiments, the one or more first magnets 110N are different kinds of permanent magnets. In additional embodiments, the one or more first magnets 110N are ferromagnetic metal that are attracted to magnets embedded within support blocks, as described in more detail below.

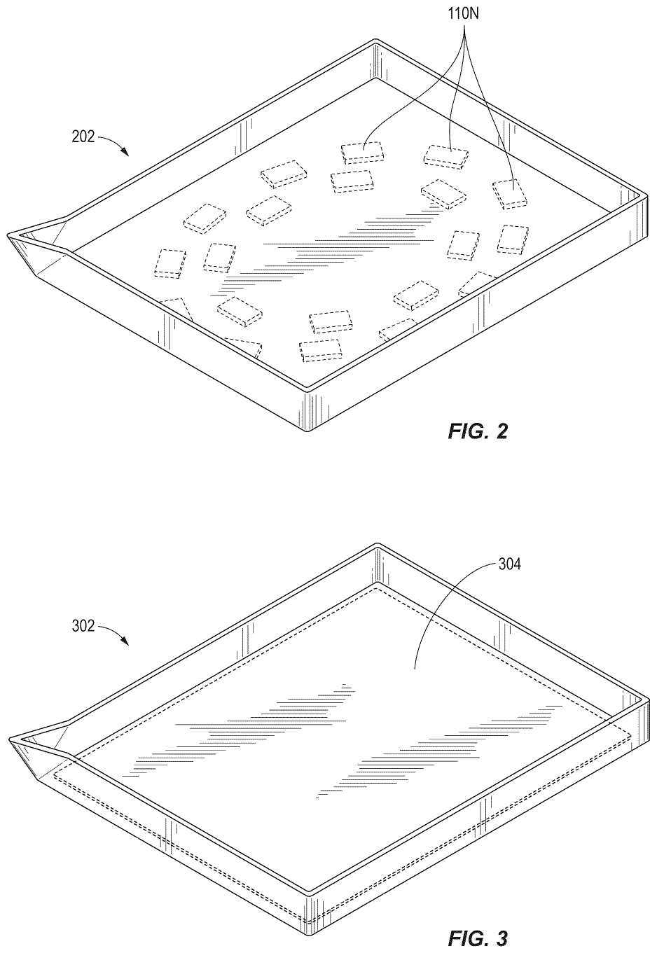

In some embodiments, the one or more first magnets 110N are embedded below the cutting surface 104 and arranged in a grid. The one or more first magnets 110N may be arranged in a rectangular grid, as depicted in FIG. 1. Additionally, in other embodiments, the one or more first magnets 110N are arranged in grids with different shapes than the rectangular grid depicted in FIG. 1, as will be discussed in the description of FIG. 2. Further, while eight embedded first magnets 110N are depicted in FIG. 1, one of ordinary skill in the art will recognize that fewer embedded first magnets 110N or additional embedded first magnets 110N may be used without departing from the scope of the present disclosure. In some embodiments, the type of permanent magnets used for the first magnets 110N are selectively chosen to place stronger permanent magnets in one section of a grid of the first magnets 110N while weaker permanent magnets are placed in another section of the grid. Selectively choosing types of permanent magnets and placing first magnets 110N in arrangements based on strength may allow a user to use different sections of the cutting board 102 to cut different food items based on the difficulty of cutting the food item. For example, stronger permanent magnets may be selected for the first magnets 110N embedded on an outside portion of a grid and weaker permanent magnets may be selected for the first magnets 110N embedded on an inside portion of the grid. This arrangement can allow for large, and difficult to cut, items that extend past the inside portion of the grid to be cut with support from stronger magnets and smaller items that are contained within the inside portion of the grid to be cut with support from weaker magnets. One of ordinary skill in the art will recognize that other arrangements may be employed without departing from the scope of the present disclosure.

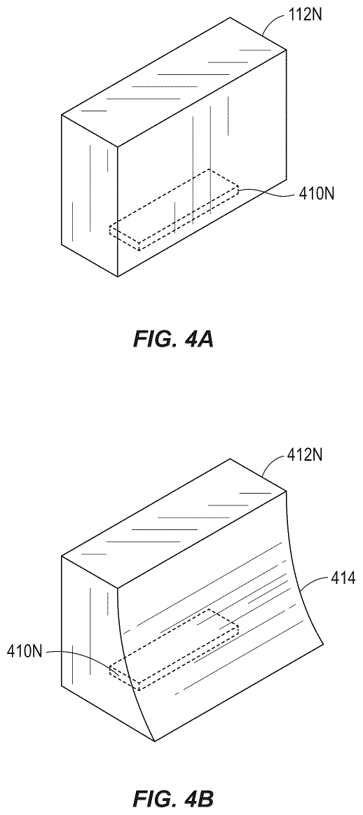

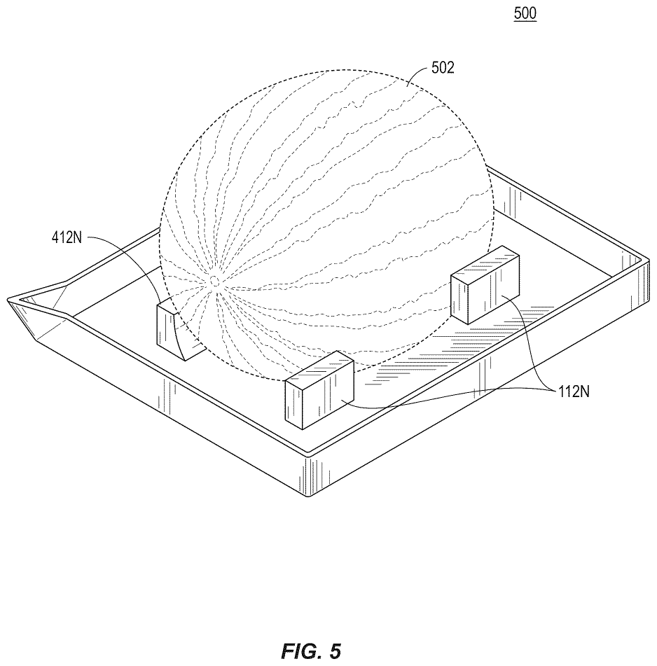

The cutting board and support block assembly 100 may also include a support block 112N. The support block 112N may include a second magnet 410N (depicted in FIG. 4A) embedded within the support block 112N. The second magnet 410N may be configured or embedded within the support block 112N in an orientation and/or location that allows the second magnet 410N to be attracted to any of the one or more first magnets 110N. The support block 112N may be configured to support a food item 502 to be sliced, as depicted in FIG. 5. In some embodiments, an attractive force (e.g., a magnetic force) between the second magnet 410N and any one of the one or more first magnets 110N may operate to hold the support block 112N in place while the support block 112N supports the food item 502 to be sliced. The attractive force between the second magnet 410N and one of the first magnets 110N can prevent the support block 112N from shifting due to lateral forces produced by a user cutting the food item 502 to be sliced. The second magnet 410N may be a permanent magnet. The second magnet 410N may be a permanent magnet of the same kind as any of the one or more first magnets 110N. The second magnet 410N may be a permanent magnet of a different kind than any of the one or more first magnets 110N.

In some embodiments, the support block 112N includes more than one of the second magnets 410N embedded within the support block 112N. In some embodiments, the support block 112N includes a second magnet 410N for each face of the support block 112N where each second magnet 410N is embedded within the support block 112N so as to be attracted to any of the one or more first magnets 110N. Each second magnet 410N embedded beneath a face of the support block 112N may allow the support block 112N to be oriented with any face of the support block 112N resting against the cutting surface 104 while being attracted to a first magnet 110N embedded beneath the cutting surface 104.

The number of support blocks 112N used in the assembly 100 may be equal to the number of first magnets 110N embedded below the cutting surface 104. The number of support blocks 112N used in the assembly 100 may be more or fewer than the number of first magnets 110N embedded below the cutting surface 104.

FIG. 2 depicts a perspective view of an example embodiment of a cutting board 202. In some implementations, the cutting board 202 includes first magnets 110N embedded beneath the cutting surface 104. The first magnets 110N may be arranged beneath the cutting surface 104 in an ovular-shaped or circular-shaped gird. The shape of the grid may correspond to the shape of a particular item to be cut. For example, the one or more first magnets 110N may be organized into a grid that is sized to encompass a melon. The cutting board 202 may include first magnets 110N organized into multiple grids. For example, one outer grid may be formed by embedded first magnets 110N that are organized into a rectangular grid and one inner grid may be formed by embedded first magnets 110N that are organized into an oval grid, or vice versa. The grids may be organized into shapes to fit specific food items or may be organized into general shapes to accommodate food items of multiple sizes and shapes. As previously mentioned, different kinds of permanent magnets may be selected for the first magnets 110N based on relative strength of the magnetic force produced by the magnet to allow the grid or grids to produce varying levels of support when a support block 112N is placed above a particular first magnet 110N.

FIG. 3 depicts a perspective view of another example embodiment of a cutting board 302. The cutting board 302 may include a ferromagnetic core 304. A ferromagnetic material as used herein describes a material that exhibits strong magnetic properties when compared with other materials. Ferromagnetic materials have magnetic domains that align in the same direction when exposed to a magnetic field, resulting in the material becoming magnetized. Ferromagnetic materials include materials like iron, cobalt, nickel, and the like. As depicted, the ferromagnetic core 304 may have a length and width that are substantially equal to a length and width of the cutting surface 104 to allow support blocks 112N to be placed at any point on the cutting surface 104 and be held to the cutting surface 104 by an attractive magnetic force produced between the ferromagnetic core 304 and a magnet embedded within the support block 112N. In some embodiments, the length of the cutting surface 104 may comprise between 15-25 inches and the width of the cutting surface 104 may comprise between 12-18 inches.

FIG. 4A depicts a perspective view of an example embodiment of a support block 112N of FIG. 1. Support block 112N, and any number of support blocks 112N may be used with the any of the previously depicted or described cutting board embodiments, e.g. cutting boards 102, 202 and 302. Support block 112N may include a solid body. Support block 112N may include a magnet 410N embedded within the solid body. Support block 112N may be made of a dishwasher safe, eco-friendly, and knife-resistant material, i.e. a rigid silicone. The magnet 410N may be embedded within a rigid silicone material within the support block 112N. The magnet 410N may be configured to be attracted to a first magnet 110N embedded beneath a cutting surface, such as the cutting surface of the previously described embodiments, i.e. cutting surface 104. In other embodiments, support block 112N includes more than one magnet 410N embedded beneath the surface of each face of support block 112N to allow any face of the support block 112N to be held to a cutting surface 104 by an attractive force produced between the magnet 410N and a first magnet 110N embedded beneath a cutting surface 104.

The support block 112N may be configured to support a food item 502 (depicted in FIG. 5) that is sliced on the cutting surface 104. The support block 112N may be so dimensioned as to fit easily within a dishwasher, kitchen drawer, or cabinet yet still be large enough to provide support to the food item 502 being cut i.e. the support block 112(N) may have a height that comprises between one and four inches, a length that comprise between two and five inches, and a width that comprises between one and three inches.

FIG. 4B depicts a perspective view of another example embodiment of a support block 412N. Support block 412N can be used in place of or in combination with support blocks 112N, as shown in FIG. 5. Support block 412N may be used with any of the embodiments depicted or described herein. Support block 412N may include a solid body. Support block 412N may include magnet 410N within the solid body as previously described. Support block 412N may include at least one curved side 414. The curved side 414 may be designed to mate against a rounded surface of the food item 502, as shown in FIG. 5. The curved side 414 may be designed to mate against a rounded surface of a particular type of food item (e.g. a tomato or onion) or the curved side 414 may be designed to mate against most rounded surfaces of a variety of food items. Support blocks 112N and 412N may be configured to be used with a particular cutting board, such as cutting boards 102, 202, and 302, when the cutting boards are designed to cut a particular food item (e.g. a watermelon).

FIG. 5 depicts a perspective view of an assembled cutting board and support block assembly 500, wherein support blocks 112N or 412N are held in place by attractive forces between first magnets 110N and second magnets 410N. The support blocks 112N and 412N are placed to support a food item 502 to be sliced. Different placements of support blocks 112N and 412N may be utilized to cut different food items 502. While food item 502 is depicted as a watermelon, one of ordinary skill in the art will recognize that food item 502 could also be another type of food item to be sliced on a cutting board (e.g. fruits, vegetables, meats, etc.) without departing from the scope of the present disclosure.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure. Furthermore, the components of the cutting board and support block assembly 100 are example components, and other components or configurations may be used. It should be borne in mind, however, that all of these and similar terms are to be associated with the appropriate physical quantities and are merely convenient labels applied to these quantities.

Reference throughout this specification to “one implementation,” “an implementation,” “some implementations,” “one embodiment,” “an embodiment,” or “some embodiments” mean that a particular feature, structure, or characteristic described in connection with the implementation or embodiment is included in at least one implementation or embodiment. Thus, the appearances of the phrase “in one implementation” or “in an implementation” or other similar terms in various places throughout this specification are not necessarily all referring to the same implementation. In addition, the term “or” is intended to mean an inclusive “or” rather than an exclusive “or.” Moreover, the word “example” or a similar term are used herein to mean serving as an example, instance, or illustration. Any aspect or design described herein as an “example” is not necessarily to be construed as preferred or advantageous over other aspects or designs. Rather, use of the word “example” or a similar term is intended to present concepts in a concrete fashion. Use of the term “a” or “an” include “one or more” unless otherwise specified.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Any components described herein can also interact with one or more other components not specifically described herein but known by those of skill in the art.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. An assembly comprising:
a cutting board comprising one or more first magnets embedded below a cutting surface of the cutting board; and
a support block comprising a second magnet or ferromagnetic metal embedded within the support block and configured to be attracted to any of the one or more first magnets, wherein the support block is further configured to support a food item to be sliced.

2. The assembly of claim 1, wherein the cutting board further comprises a raised lip that extends along a perimeter of the cutting board.

3. The assembly of claim 2, further comprising a spout defined within the lip, wherein the spout spans from the cutting surface to a top edge of the lip.

4. The assembly of claim 3, wherein the lip and the spout are comprised of a rigid silicone material.

5. The assembly of claim 3, wherein the lip has a height of between one to three inches.

6. The assembly of claim 1, wherein the one or more first magnets and the second magnet are permanent magnets.

7. The assembly of claim 1, wherein the one or more first magnets are organized into a grid that is sized to encompass a melon.

8. The assembly of claim 1, wherein at least one side of the support block is curved to mate against a rounded surface of the food item.

9. The assembly of claim 1, wherein each of the one or more first magnets and the second magnet or ferromagnetic metal is embedded within a rigid silicone material.

10. The assembly of claim 1, further comprising a plurality of support blocks, which include the support block, wherein each support block of the plurality of support blocks includes the second magnet or ferromagnetic metal, which are to be attracted to any of the one or more first magnets.

11. A system comprising:
a cutting board comprising a ferromagnetic core embedded below a cutting surface of the cutting board; and
a support block comprising a magnet embedded within the support block and configured to be attracted to the ferromagnetic core, wherein the support block is further configured to support a food item to be sliced.

12. The system of claim 11, wherein the cutting board further comprises a raised lip that extends along a perimeter of the cutting board.

13. The system of claim 12, further comprising a spout defined within the lip, wherein the spout spans from the cutting surface to a top edge of the lip.

14. The system of claim 11, wherein at least one side of the support block is curved to mate against a rounded surface of the food item.

15. The system of claim 11, further comprising a plurality of support blocks, which include the support block, wherein each support block of the plurality of support blocks includes the magnet that is attracted to the ferromagnetic core.

16. The system of claim 11, wherein a length and a width of the ferromagnetic core are substantially equal to a length and a width of the cutting surface.

17. The system of claim 16, wherein the length of the cutting surface is between 15-25 inches and the width of the cutting surface is between 12-18 inches.

18. A support block comprising:
a solid body;
a first magnet embedded within the solid body, wherein the first magnet is embedded within a rigid silicone material within the solid body; and
wherein the first magnet is configured to be attracted to a second magnet or a ferromagnetic metal embedded below a cutting surface of a cutting board, wherein the support block is configured to support a food item that is to be sliced.

19. The support block of claim 18, wherein at least one side of the support block is curved to mate against a rounded surface of the food item.

20. The support block of claim 18, wherein a height of the support block is between one and four inches, a length of the support block is between two and five inches, and a width of the support block is between one and three inches.
